(19) United States
(12) Patent Application Publication
(10) Pub. No.: US 2005/0157863 A1
(43) Pub. Date: Jul. 21, 2005

(54) Customizable proactively prompted IP telephone service

(76) Inventor: Rodney J. Sizemore JR., Harrison, OH (US)

Correspondence Address: LAFKAS PATENT LLC, 7811 LAUREL AVENUE, CINCINNATI, OH, 45243, US

(21) Appl. No.: 10/793,300

(22) Filed: Mar. 4, 2004

Related U.S. Application Data
(60) Provisional application No. 60/538,022, filed on Jan. 21, 2004.

(51) Int. Cl. H04M 3/42; G06F 15/16

(52) U.S. Cl. 379/211.01; 379/211.02; 709/227

(57) ABSTRACT

The present invention relates to method for processing telephone communications by connecting the telephone communications to computer servers and then determining the preferred locations to which the call receiver prefers to receive the telephone communications. The call receiver connects to the computer servers through a computer interface that has a set of modules associated with the call receiver. The computer interface is prompted by a call manager to update the set of modules that the call receiver modifies.

### CROSS-REFERENCE TO RELATED APPLICATIONS

This application for a patent claims priority to U.S. Provisional Application No. 60/538,022 as filed Jan. 21, 2004.

### BACKGROUND

1. Field of the Invention

The present invention relates to computer processing of incoming telephone communications, and more particularly relates to processing incoming telephone communications through local or worldwide Internet connections based on one or more predetermined communication locations of the communication receiver.

2. Discussion of the Prior Art

For decades, users of telephone communications connected to public switched telephone networks' (PSTN's) wires in homes, offices or by public phones. The wires connected to the PSTN's which then connected desired outbound and incoming telephone communications via the computer systems of the PSTN's.

Advancing technology has increased the data transmission capacity of telephone systems, improved the services provided by data networks, and cultivated the use of data networks as a generally accepted means of communication. This advancing technology has also developed the need for connecting the telephone system directly to data networks. To meet this demand, Direct Data Accesses (DDA's) have been developed, wherein the exchange of the telephone network is connected and converted to the data network.

Today, voice-over-Internet protocol (IP) technology is an advanced method of communication similar in general theory and application to that of the PSTN's. A fundamental difference, however, between the voice-over-IP technology and a typical PSTN is that voice-over-IP technology allows for greater audio and visual communications options, from in particular, PC to phone, phone to PC, and/or phone to phone. Typical PSTN's permit merely phone to phone communication. Connections and relationships between PSTN's and PC technology are well known in the art.

As the voice-over-IP technology grows in availability and actual use, gateways have been developed to allow for better connection between signals from PSTN's to PC's and vice-versa. See, for example, U.S. Pat. No. 6,445,694 to Schwartz, wherein a subscriber employs a web interface to populate a database with preference data subsequently used by a host IP services processor connected to the PSTN such that incoming and outgoing telephone calls are handled based on the preference data.

See too, for example, U.S. Patent Application Publication No. 2003/0108176 to Kung, et al., wherein a method and system for dynamic call forwarding is described such that when a predetermined telephone number is called from a telephone other than a subscriber's home telephone, the subscriber enters a code for location registration which is subsequently used to reroute the telephone call to the location registration.

U.S. Pat. No. 6,574,329 to Takeuchi et al. describes an incoming call processing method for enabling immediate answering of the greatest possible number of incoming calls without generating unserviced phone calls, by determining whether to answer the incoming call immediately or to answer the incoming call at a later time at which the volume of incoming call traffic intensity is light.

Several variations of redirecting incoming and outgoing telephone communications via voice-over-IP technology are known and described in the above-identified examples. Some of the examples may require immense amounts of computer memory, computer hardware and software, and may be limited in a user's ability to update the system.

Other Internet-based methods may also require immense amounts of bandwidth to be accessed in order to update changes made to one or more users's predetermined locations. That is, for example, if a user changes a predetermined location to which to receive an incoming telephone call from an office telephone number to a mobile telephone number, typically, the entire Internet-based page must be updated for all the users of the related system either at predetermined intervals of time and/or by refreshing/reloading the page at which point no changes might have been made to the page and/or portions of the page. Updating the entire web-accessed page may require a great amount of bandwidth to transfer all the memory for the entire webpage to the user. Further, usually such Internet interfaces are automatically updating at predetermined intervals of time, for example, every fifteen minutes, which means that a large amount of bandwidth is required at each of the predetermined intervals of time, whether or not changes have been made to any predetermined locations of any of the users on the system.

Thus, what is desired, and not taught or suggested in the prior art, is a method of accessing an Internet interface to process incoming calls to a predetermined location such that the Internet interface relates to various modules associated with users on a system, wherein the various modules are proactively prompted to reduce actual bandwidth necessary for updating.

### SUMMARY

A method of processing one or more telephone communications to one or more users comprising the steps of connecting the one or more telephone communications to one or more computer servers, determining one or more predetermined locations to which the one or more users prefer to receive the one or more telephone communications, wherein the one or more users connect to the one or more computer servers by way of one or more computer interfaces comprising of one or more sets of modules associated with the one or more users such that the one or more sets of modules comprise proactive prompting; and delivering the one or more telephone communications to the one or more predetermined locations.

A computer interface for processing telephone communications comprising one or more call managers connected to the computer interface through a computer application, and one or more sets of modules associated with one or more users on a network, wherein the one or more sets of modules comprise properties relating to the one or more users on the network that may be modified by the one or more users, such that when the properties relating to the one or more users on a network is modified, the computer interface is prompted by the one or more call managers to reload the properties of the modules.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a schematic diagram of an illustrative arrangement of hardware components allowing for the infrastructure to implement the various exemplary embodiments of the method of the present invention.

FIG. 2 is a schematic diagram illustrating the relationship of the modules of the computer application according to the various exemplary embodiments of the present invention.

### DETAILED DESCRIPTION

The various exemplary embodiments of the present invention comprise a new method of processing one or more incoming telephone communications from one or more typical public switched telephone networks (PSTN's) or from the Internet through one or more voice-over-IP application servers via a computer interface requiring less computer memory and accessed bandwidth in order to modify one or more user's location preferences.

Throughout the description herein of the various exemplary embodiments of the present invention, “telephone communications” is defined, unless otherwise noted, to mean audio and/or visual communications using any presently known or future developed telephone land lines, mobile (i.e., no direct physical connections to a physical telephone line), cable networking, and/or Internet connections.

The term “location” herein is to be defined, unless otherwise noted, as a means by which a first user is contacted and/or connected to by another user trying to contact the first user via telephone communications. Examples of “locations” herein may include an office telephone, a mobile/cellular telephone, a home telephone, a voice-mail message on any of these or other locations, a PC connection, and the like.

“Webpage” is defined herein as any set of data that is shared and accessible to other computer users via the Internet, Intranet and/or any other shared computer networking. The webpage may comprise any web and/or business portal; and/or one or more portions, segments and/or frames of data, each of which may be modified, accessed and saved individually.

In the various exemplary embodiments of the present invention, one or more incoming telephone communications connect from one or more PSTN's or Internet to one or more local computer servers via a gateway device. The gateway device preferably is able to convert IP based media packets into standard PSTN traffic, and vice versa. In a most preferred embodiment, the gateway device communicates with a call manager of one or more local computer applications of one or more computer servers such that the gateway device may automatically perform trunk sizing and allocation between the IP computer servers and the PSTN.

The call manager of the various embodiments of the present invention directs the incoming telephone communications to one or more locations preferred by a user to which the incoming telephone communications is meant. Thus, the call manager connects with one or more computer applications connected to the computer interface of each of the one or more users of a particular network to maintain, modify as instructed, and direct incoming telephone communications based on the location preferences of the one or more users of the particular network.

The computer interface of the various exemplary embodiments of the present invention comprises one or more sets of modules associated with each of the one or more users of a particular network. It is preferred that the particular network is a closed network, that is, for example, wherein access to the network is limited to certain users and not open for public access. The computer is preferably secured with a computer firewall.

The one or more sets of modules may comprise one or more location preferences for each of the users at a particular time. That is, for example, one user may set her location preferences such that the call manager will direct all incoming telephone communications to the one user's office telephone. However, as the one user leaves the office for a lunch meeting, she may, for example, set her location preferences to instruct the call manager to direct all incoming telephone communications to the one user's mobile telephone or to the one user's office phone voice mail.

Further, the computer interface of the computer application comprises a monitoring means by which each of the one or more users on the particular network may, by viewing the computer interface, observe the location of each of the other one or more users on the particular network. For example, if user A is interested in contacting user B, user A may review the computer interface to learn that according to the location preferences of user B, user B is in the office of user B.

The computer interface of the various exemplary embodiments of the present invention allows for viewing of a location, availability, etc. of a user on a particular shared network, and allows for direct connection to the other users of the particular shared network if the computers are IP telephonically equipped. The call manager of the various exemplary embodiments preferably directs incoming telephone communications to the preferred location without prompting or notifying the user placing the telephone communication.

In the various exemplary embodiments of the computer interface of the present invention, each of the one or more users of the network is listed in a matrix visible on the computer interface. The one or more users could also be listed, for example, by department, role, seniority, location, interval of time since last log-in to the network, and the like.

The computer interface of the various exemplary embodiments of the present invention may comprise of one or more icons associated with each of the one or more users on the network. For example, the one or more icons may comprise a telephone symbol, an envelope, a figure representing a person, a house, a mobile telephone, voice mail box, etc. Each of the one or more icons may relate to and/or represent the location and/or availability of each of the one or more users on the network.

For example, if a user C has a house icon next to his name, the house icon may represent that the user C is at his home and thus, his home telephone is the preferred location at which to contact him. User D, however, may have an icon of a telephone next to his name, which in the particular network to which he is a user, may represent that his current location is his office telephone.

Further, the icons of the various exemplary embodiments of the present invention may be modified, for example, by color, visual intensity, the overlay of another icon, and the like, to identify the availability of the one or more users on the network. For example, the icon of a telephone for a user E may have an “X” superimposed over the icon of a house associated with user E. In such a case, the superimposition of the X over the house icon may represent that user E is at home, as set my his preference location through the computer interface, but that he is not available at that time to receive any telephone communications.

The computer interface of the various exemplary embodiments of the present invention may comprise allowing the one or more users to modify preferred locations based on the origin of the incoming telephone communication. That is, for example, a user may direct that any incoming telephone communications from other members of a particular group be sent directly to his office phone, while any incoming telephone communications from his wife be directed to his mobile telephone.

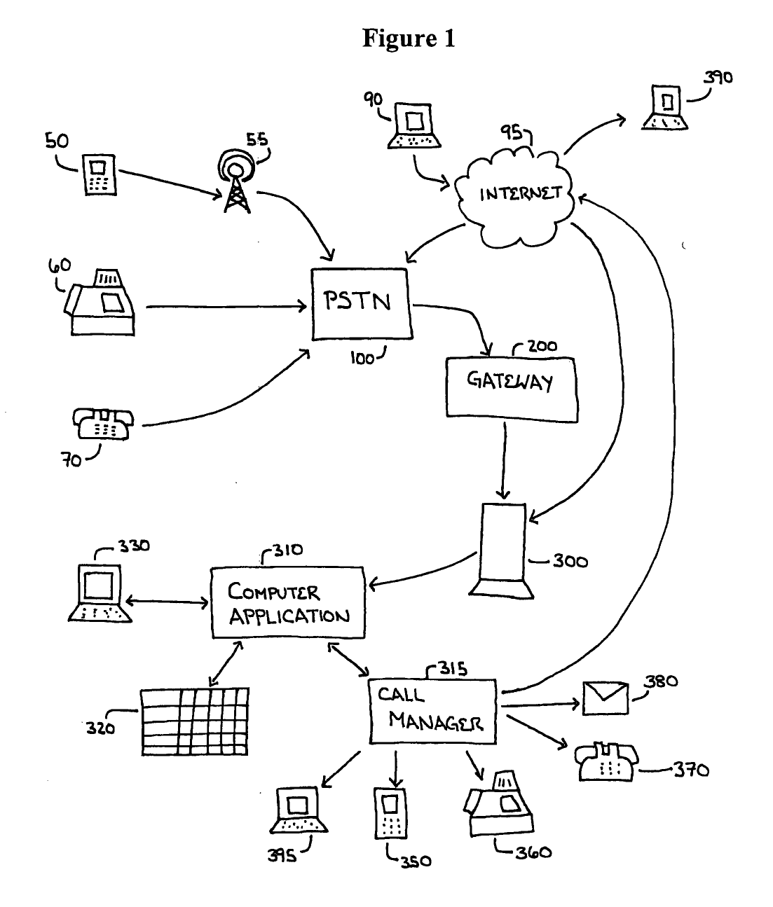

FIG. 1 is a schematic representation illustrating the arrangement of hardware according to the various exemplary embodiments of the present invention. A telephone communication may be initiated from, for example, a mobile phone 50 via a transmission facility 55, a typical “land line” telephone 70, and/or a facsimile machine 60. The telephone communication is then routed through the PSTN 100. An IP telephone communication may also be initiated from a remote PC 90 via the Internet 95 and to the PSTN 100.

The PSTN 100 then directs the telephone communication to the gateway device 200 to convert any standard PSTN traffic into IP based media packets such that the incoming telephone communication can be read by the computer server 300 of a particular network. The computer server 300 forwards the incoming telephone communication to the one or more computer applications 310 associated with telephone communications for the network.

The one or more computer applications 310 may receive modifications from users via one or more computer interfaces 330. The modifications are stored and loaded into the modules 320.

The incoming telephone communication, having been sent to the one or more computer applications 310 is directed by the call manager 315, based on the properties of the modules 320, to any of the preferred locations of, for example, a user's mobile telephone 350, a user's land line telephone 370, a facsimile machine 360, voice mail 380, PC 395 and/or computer 390 via the Internet 95.

In the various exemplary embodiments of the present invention, the icons associated with each of the one or more users may allow for direct access to the other users. That is, by clicking on the icon of the preferred location of another user, one may be directly contacted to that user's preferred location via voice-over IP. Thus, a user may contact another user using his computer a device by which to send a telephone communication to another user. Likewise, one may use his computer to receive incoming telephone communications as well.

The locations, availability, time on-line, and similar properties associated with each of the one or more users comprise modules of each user. A network may comprise any number of modules representing any of a number of possible variables and properties that one may desire to be associated with each user of a network. The examples of such possible variables and properties to be associated with the one or more users of a network herein are not meant to be exhaustive.

The network of the various exemplary embodiments of the present invention to which the one or more users are connected need not be a network to which the one or more users are connected via wire. That is, for example, the one or more users may connect to the network via a wireless connection and/or via a wireless Internet connection.

The various exemplary embodiments of the present invention further comprises data regarding an incoming telephone communication to be optionally saved to a memory of the one or more computer servers and/or transferred to the one or more users to which the incoming telephone communication is directed.

For example, when a customer calls a company, the telephone communication is routed through the computer server as described herein. The one or more computer server recognizes the customer by, for example, comparing the telephone number or other identification of the customer to one or more saved or available customer databases in the memory of the one or more computer servers, and forwarding the database information associated with the customer to the one or more users to which the incoming telephone communication is directed.

The one or more computer servers may, for example, prompt an originator of an incoming telephone communication to input data such as, for example, telephone number, name, address, age, gender, birth date, account or numeric identification, and the like. Such input data may be forwarded to the computer interface of the one or more users to which the incoming telephone communication is directed such that the one or more users may view the input data and/or any associated information regarding the originator of the incoming telephone communication saved from a memory of the one or more computer servers.

The modules of each of the one or more users is saved in the memory of the application server and accessed, as needed by the call manager. The call manager may need to access the modules, for example, when processing an incoming telephone communication to one or the one or more users of the network.

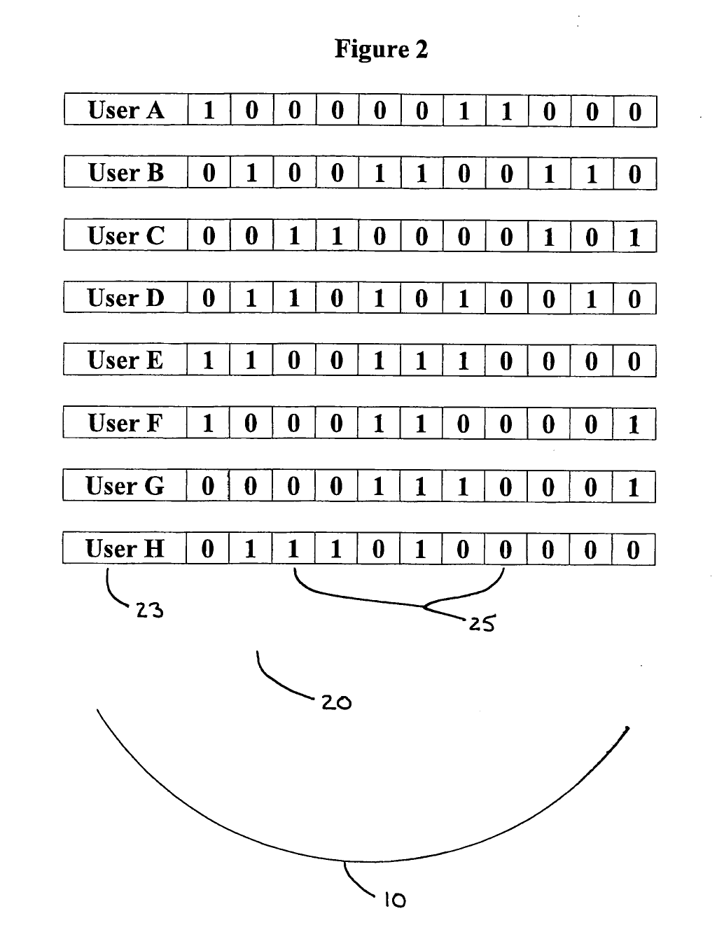

FIG. 2 represents a simple illustration of one variation of the organization of the modules. As shown in FIG. 2, each of the one or more user modules 23 on a network 10 comprises one or more module properties 25. Each of the module properties 25 may comprise preferred locations, availability, one or more associated working groups or departments within an organization, and the like.

Through the computer interface, the one or more users, represented by user modules 23, may modify the one or more module properties 25 of their modules 20. That is, for example, if one user wants all incoming telephone communications to be directed to his office phone, the modules associated with that user will show that calls should be directed to the office phone and not to other phones.

When a user modifies the one or more properties of his modules, the computer interface is prompted to update the modifications such that the computer interface for each of the one or more users on the network shows the modifications.

That is, the computer interface, via the one or more computer applications and one or more computer servers, preferably does not reload or update redundant properties of the modules unless modifications have been made to any of the properties of the modules. Rather, it is preferred that the properties of the modules are uploaded when based on actual changes made to the modules rather than at predetermined periods of time and/or when prompted by a user to reload the data. Reloading the data when changes have not been made to the modules in effect wastes bandwidth and access memory by reexamining and reloading the same exact data as was previously on the computer interface. Pushing and uploading merely when modifications to the properties of the modules are made requires less overall processing memory and drastically decreases the amount of bandwidth needed to access changes and update to the modules.

Preferably, in the various exemplary embodiments of the present invention, the modules are not uploaded or reexamined by the computer at predetermined intervals of time, and are uploaded and reexamined when prompted based on modifications made to the module properties by users on the particular shared network.

Decreasing the amount of processing memory and amount of bandwidth required allows for access to the computer interface via the Internet at faster rates and without tying up availability of accessible bandwidth to all users in a community. For example, “hot spots” are areas of wireless Internet availability that are becoming more prevalent in places where people may gather, for example, coffee shops, airports, gyms, etc.

The number of people trying to access the Internet in hot spots is typically indirectly proportional to the speed and/or availability of access. In other words, the greater the number of people accessing the Internet via a hot spot usually means that the speed and/or availability of the Internet access will be slower as the total available bandwidth may be limited.

Most Internet webpages, even when updating at a predetermined interval of time, reload all the information on the particular webpage even if nothing has changed on the page between the initial downloading of the webpage or portions of the webpage and the updating of the same webpage.

In the various exemplary embodiments of the present invention, when accessing the computer interface, whether through a local network or the Internet, the computer interface updates and loads modifications to the modules of the one or more users of the particular network preferably when modifications are made to the modules. Thus, the overall processing memory and accessed bandwidth requirements are dramatically decreased as the modules are only updated and reloaded when a change has been made, rather than at predetermined periods of time and/or when refreshed by one or more users at which point no changes may have been made.

The various exemplary embodiments of the present invention further comprises a method of processing data via an Internet connection. One or more users first connects to a webpage on the Internet and downloads the data of the webpage to one or more computer interfaces of the one or more users by which the one or more users may view the data from the webpage. As the data of the webpage is modified at the source of the webpage, the call manager prompts the computer interface that data associated with the modules of the network has been modified. Upon being prompted of the modifications, the computer interface reloads and/or updates the data associated with the modules. That is, the one or more computer interfaces of the one or more users need not unnecessarily prompt the webpage to update and/or reload in order to receive the modified data. Downloading and/or updating the data associated with the modules merely when the modules are modified decreases the overall amount of bandwidth required to transmit the data, and avoids reloading redundant data, that is, none of the data associated with the modules that is not modified, to the one or more computer interfaces.

Typically, webpages and web browsers are arranged such that a user views the data available on a particular website at the instant that the user first connects to the website. Some, if not all, of the data associated with the particular website may be modified by the owner/programmer/server of the website soon after the user connects to the website, but the user will not receive the updated data until an action is taken at the user's computer interface.

That is, for example, the user may refresh the webpage manually by clicking a “refresh” button or the web browser of the user may be programmed to reload a website being viewed at a predetermined interval of time of, for example, every ten minutes. However, in both of these examples, the computer interface of the user reloads all the data of the website whether or not changes have been made to the page or portion of the page. Reloading such a large amount of data without reason, that is, no new information is on the page, and requiring such a great deal of bandwidth may be a burden to the Internet connection, especially in wireless hot spots wherein the bandwidth-limited wireless Internet connection is being shared and utilized by possibly numerous people.

The exemplary embodiment of the present invention decreases the overall amount of memory and bandwidth required for such a connection during a session connected to the Internet, especially when modifications have not been made to the webpage and/or portions of the webpage, and reduces the amount of redundant data reloaded.

Examples of the exemplary method of the present invention may include, for example, viewing a news webpage that sends updated news information on a changing news story to a user viewing the webpage when the updated news is available rather than requiring the user to continuously recheck and reload the webpage for news updates. Another example may be forwarding an email to one or more users' email accounts upon receiving the email at the computer server by the call manager's prompting the computer interface to reload the mail messages from a mail server of the computer servers, rather than programming the computer interface to check for mail in the mail server every five minutes, wherein there may not be any new incoming mail.

In the various exemplary embodiments of the present invention, an incoming telephone communication is processed by first connecting the incoming telephone communication to the one or more computer servers. The incoming telephone communication may be from a standard PSTN, a wireless network, Internet, and/or combinations thereof. The one or more application servers may comprise of an Internet web site, an Internet web server, a local network application server, or a localized PC.

Upon connecting the incoming telephone communication to the one or more computer servers and through the one or more computer applications, the call manager connected to the one or more computers determines the one or more predetermined locations to which the incoming telephone communication is to be directed. The one or more predetermined may include, for example, a standard telephone, a wireless telephone, and/or a PC.

The one or more predetermined locations determined by the call manager for directing the incoming telephone communication is established by the one or more users via the computer interface connected to the one or more application servers. The computer interface comprises one or more sets of modules associated with each of the one or more users of a particular network. The modules may be modified at any time the one or more users have proper access to the computer interface. Modifications to the modules of the computer interface comprise proactive prompting, i.e., preferably only when modifications to the modules of the computer interface are made is the computer interface prompted by the call manager to update and/or upload the modified data associated with the modules of the network thereby decreasing the overall amount of access memory and required bandwidth needed to update the computer interface across the particular network.

Once the call manger determines the one or more predetermined locations for the incoming telephone communication, the incoming telephone communication is routed and delivered to the one or more predetermined locations. Preferably, in the various exemplary embodiments of the present invention, the routing and delivery by the call manager of the incoming telephone communications is automatic.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

1. A method of processing one or more telephone communications to one or more users comprising the steps of:
connecting the one or more telephone communications to one or more computer servers;
determining one or more predetermined locations to which the one or more users prefer to receive the one or more telephone communications, wherein the one or more users connect to the one or more computer servers by way of one or more computer interfaces comprising one or more sets of modules associated with the one or more users such that the one or more sets of modules comprise proactive prompting; and
delivering the one or more telephone communications to the one or more predetermined locations.

2. The method according to claim 1, wherein the telephone communications are incoming telephone communications.

3. The method according to claim 1, wherein the telephone communications are incoming telephone communications comprises audio data, visual data, or combinations thereof.

4. The method according to claim 1, further comprising forwarding data associated with an originator of the one or more telephone communications to the one or more users to which the one or more telephone communications is delivered.

5. The method according to claim 4, wherein the data associated with the originator of the one or more telephone communications is provided by the originator.

6. The method according to claim 4, wherein the data associated with the originator of the one or more telephone communications is in a memory of the one or more computer servers.

7. The method according to claim 1, further comprising routing the one or more telephone communications through a gateway device before connecting the one or more telephone communications to the one or more computer servers.

8. The method according to claim 1, wherein the one or more computer interfaces upload data associated with modifications made to the one or more sets of modules by the one or more users when prompted by one or more call managers of the one or more computer servers that the data has been modified.

9. The method according to claim 1, wherein the one or more predetermined locations comprise mobile telephones, land-line telephones, facsimile machines, IP telephony software, voice mail, or combinations thereof.

10. The method according to claim 1, wherein the one or more sets of modules associated with the one or more users comprises predetermined locations of the one or more users, availability of the users, associated groups of the one or more users, or combinations thereof.

11. A computer interface for processing telephone communications comprising
one or more call managers connected to the computer interface through a computer application; and
one or more sets of modules associated with one or more users on a network, wherein the one or more sets of modules comprise properties relating to the one or more users on the network that may be modified by the one or more users, such that when the properties relating to the one or more users on a network are modified, the computer interface is prompted by the one or more call managers to reload the properties of the modules.

12. The computer interface according to claim 11, wherein the computer interface does not reload the properties of the modules unless prompted by the one or more call managers.

13. The computer interface according to claim 11, wherein the properties of the modules comprise predetermined locations of the one or more users, availability of the users, associated groups of the one or more users, or combinations thereof.

14. The computer interface according to claim 13, wherein the one or more predetermined locations comprise mobile telephones, land-line telephones, facsimile machines, IP telephony software, voice mail, or combinations thereof.

15. The computer interface according to claim 11, wherein the telephone communications are incoming telephone communications.

16. The computer interface according to claim 1 1, wherein the telephone communications are incoming telephone communications comprises audio data, visual data, or combinations thereof.

17. The computer interface according to claim 11, wherein the computer interface is connected to a call manager for directing telephone communications based on the properties of the one or more sets of modules.

18. A method of processing data via the Internet comprising:
examining data of a webpage connected to the Internet;
loading of the data associated with the webpage to one or more computer interfaces of one or more users;
prompting by one or more call managers of one or more computer servers connected to the one or more computer interfaces, wherein the prompting identifies to the one or more computer interfaces that the data associated with the webpage or portion of the webpage has been modified; and
reloading the data associated with the webpage or the portion of the webpage to the one or more computer interfaces, wherein reloading the data includes loading the data associated with the webpage or the portion of the webpage that has been modified.

19. The method according to claim 18, wherein the webpage comprises a web portal.
